(19) United States
(12) Patent Application Publication
(10) Pub. No.: US 2004/0113469 A1
(43) Pub. Date: Jun. 17, 2004

(54) Latch indication apparatus for strollers and car seats

(76) Inventor: Chuan-Ming Yeh, Chia-I City (TW)

Correspondence Address: RABIN & Berdo, PC, 1101 14TH STREET, NW, SUITE 500, WASHINGTON, DC, 20005, US

(21) Appl. No.: 10/724,726

(22) Filed: Dec. 2, 2003

(30) Foreign Application Priority Data
Dec. 17, 2002 (TW) 91220529

(51) Int. Cl. A47C 31/00; B60N 2/28

(52) U.S. Cl. 297/183.1; 297/183.2; 297/183.4; 297/250.1

(57) ABSTRACT

A latch indication apparatus for strollers and car seats has a display spot on an outer side of an anchor dock of a stroller frame corresponding to a latch section of the anchor dock. When the car seat is coupled on the anchor dock, users can confirm secured coupling and anchoring of the car seat on anchor dock through viewing the display spot thereby to prevent incomplete coupling and avoid loosening of the car seat from the stroller frame to achieve improved safety.

### FIELD OF THE INVENTION

The invention relates to a latch indication apparatus for strollers and car seats that enables a car seat to be removable coupled on an anchor dock of a stroller and has a display spot on the anchor dock to confirm secured coupling of the car seat and the anchor dock, to achieve safety.

### BACKGROUND OF THE INVENTION

Car accidents are frequently happen to young children. A car seat can reduce this risk. According to regulations, young children sitting in a car must be seated in car seats to protect the children when the car moves.

Many types of car seats are available on the market and may be selected according to the age and size of the children. For instance, for children less than one year old (about ten kilograms of weight), a bed type car seat is preferable because it provides a better protection. Such type of car seat usually has a handle to double as a portable cradle to facilitate carrying for outdoor use.

The handle generally is pivotally engaged on the car seat in the middle portion. For carrying, the handle may be pivotally moved upwards. When not in use, the handle may be pivotally moved to the edge of the car seat to facilitate moving or tending of the child.

The turning handles of the present car seats mostly adopt a simple pivotal coupling to provide a turning function. When the car seat is used as a portable cradle, it tends to sway and rock while it is carried through the handle. Moreover, the handle usually has a selected angle to allow the car seat to reach a stable gravity condition while moving. However, without proper indication, the car seat could be lifted and carried without the handle moving to a stable angle. As a result, the car seat could sway greatly at the moment of lifting, trying to reach a desired balance.

To avoid the aforesaid problem, some products provide an anchor function for the handle. The handle may be moved into a plurality of positions to achieve a latching and anchoring effect so that when the car seat is lifted and moved it does not sway against the handle, thereby safety is improved. However, the present handle anchoring structures mostly adopt quite complicated designs. They are not well accepted by users. One of the reasons is that it is difficult to ensure whether the handle has reached the anchor position. Users have to consider whether the handle is properly latched. The present anchor structures generally indicate the latch and anchor condition by a click sound without using other distinguishable means. This is not very satisfactory. For instance, when the ambient noise is huge, the click sound could be drowning out and not recognizable.

### SUMMARY OF THE INVENTION

In view of the aforesaid disadvantages, the first object of the invention is to provide a display spot on an anchor dock of the stroller frame corresponding to a latch section of the anchor dock so that when the car seat is coupled on the latch section of the anchor dock users can clearly see and confirm the secured coupling of the car seat. The second object is the anchor dock, preventing disconnection of the stroller frame from the car seat, thus achieving the desired safety effect.

The foregoing, as well as additional objects, features and advantages of the invention will be more readily apparent from the following detailed description, which proceeds with reference to the accompanying drawings. The drawings are only to serve for reference and illustrative purposes, and are not intended to limit the scope of the invention.

### BRIEF DESCRIPTION OF THE DRAWINGS

FIG. 1 is a schematic view of the car seat according to the invention.

FIG. 2 is a schematic view of the invention showing the car seat anchoring on a stroller frame.

FIG. 3 is a schematic view of the anchor dock of the invention.

FIG. 4 is a schematic view of the invention showing the car seat coupling on the anchor dock.

FIG. 5 is a sectional view of a second embodiment of the invention in an operation condition.

FIG. 6 is a schematic view of the second embodiment of the invention showing the car seat coupling on the anchor dock.

### DESCRIPTION OF THE PREFERRED EMBODIMENTS

Embodiment 1:

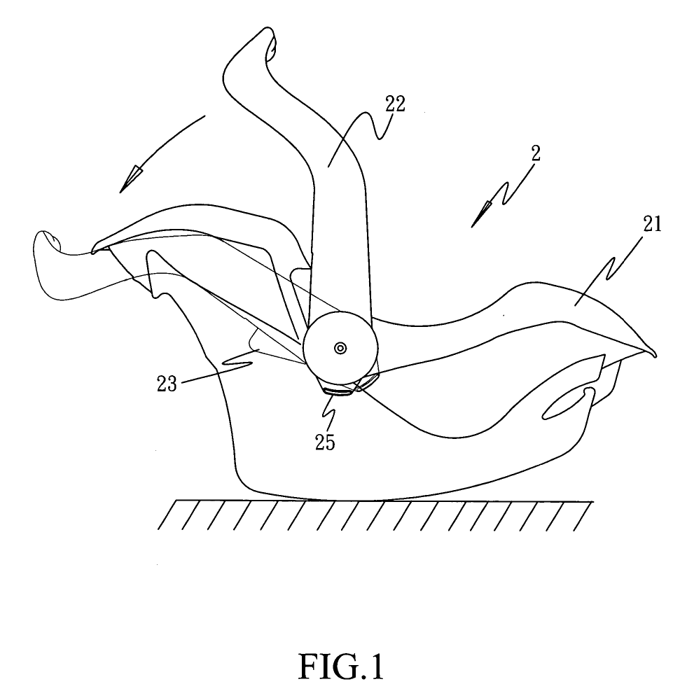

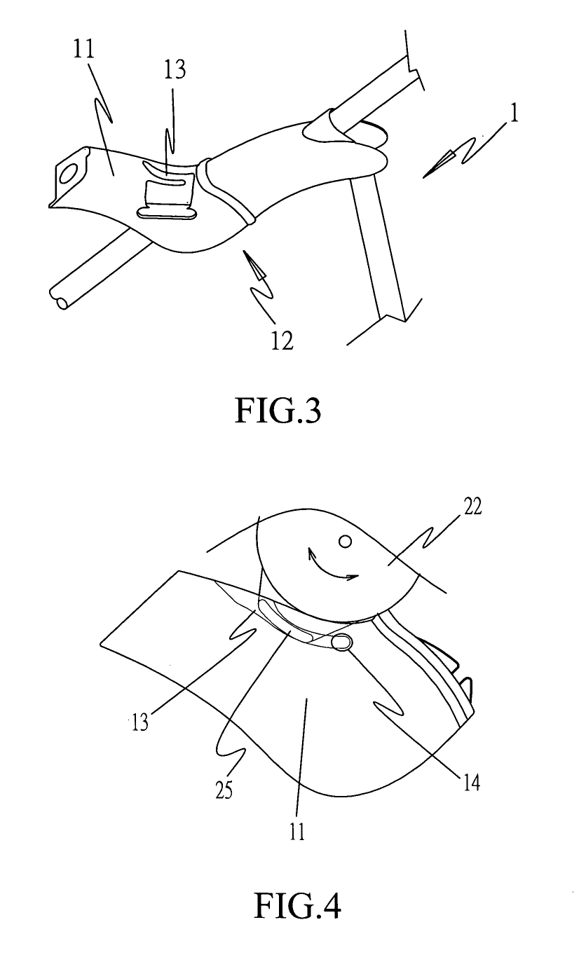

Referring to FIGS. 1, 2, 3 and 4, the latch indication apparatus for strollers and car seats according to the invention mainly aims at providing a secured coupling for a car seat 2 on a stroller frame 1.

The car seat 2 (referring to FIG. 1) includes a body 21, a handle 22 and a pair of release devices 23. The body has a housing compartment 24 to accommodate a child. The handle 22 is pivotally engaged on two sides of the body 21 and turning. The release devices 23 are located between the body 21 and the handle 22 to adjust the turning position of the handle 22. The handle 22 has a lower side extended to form a latch member, 25 which turns with the handle 22 to couple with the stroller frame 1.

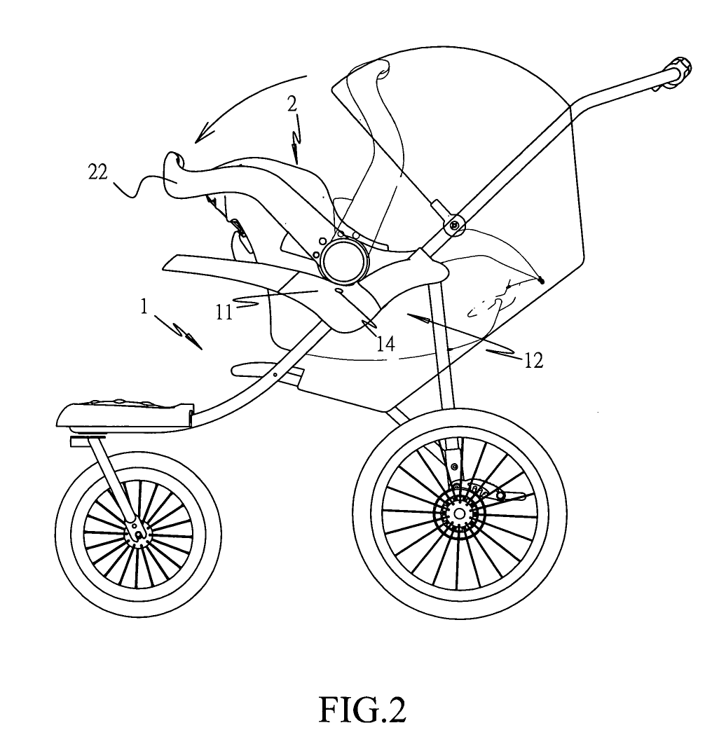

The stroller frame 1 (referring to FIGS. 1 and 2) mainly is to anchor the car seat 2. It includes at least an anchor dock 11 to couple with the car seat 2. The anchor dock 11 may be fastened to or released from the stroller frame 1. In this embodiment, the anchor dock 11 is extended from a folding joint 12. The anchor dock 11 has at least one latch section 13 (in this embodiment, the latch section 13 is a slot) to couple with a latch member 25 of the handle 22 to form an anchor condition. The anchor dock 11 further has a display spot 14. In this embodiment, the display spot 14 is an opening or notch corresponding to the latch section 13.

By means of the structure set forth above, after the car seat 2 is mounted onto the stroller frame 1, turn the handle 22, the latch member 25 at the lower side of the handle 22 also is turned to wedge in the latch section 13 of the anchor dock 11 to achieve the purpose of anchoring the car seat 2. The display spot 14 located on an outer side of the latch section 13 can clearly indicate whether the latch member 25 has been wedged in the latch section 13. Thereby, incomplete coupling of the car seat 2 and the stroller frame 1 may be prevented, and the risk of disconnecting the car seat 2 from the stroller frame 1 may be avoided to achieve the desired safety effect.

Embodiment 2:

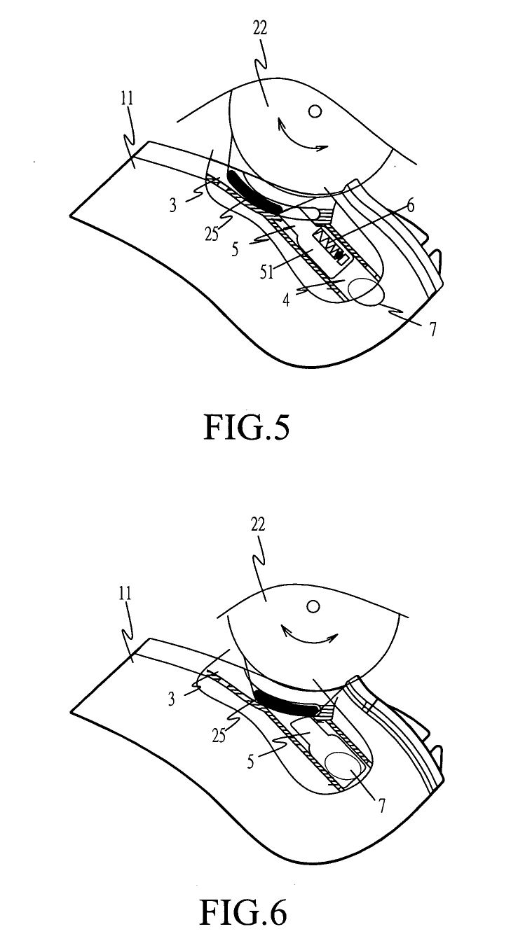

Referring to FIGS. 5 and 6, the car seat 2 (also referring to FIG. 1) includes a body 21, a handle 22 and a pair of release devices 23. The body 21 has a housing compartment, to accommodate a child. The handle 22 is pivotally engaged on two sides of the body 21 and turning. The release devices 23 are located between the body 21 and the handle 22 to adjust the turning position of the handle 22. The body 21 or the handle 22 has a lower side extended to form a latch member 25 which turns with the handle 22 or directly through the body 21 to couple with the stroller frame 1 (as shown in FIG. 2).

The stroller frame 1 (referring to FIGS. 1 and 2) mainly is to anchor the car seat 2. It includes at least an anchor dock 11 to couple with the car seat 2.

As shown in FIGS. 5 and 6, the anchor dock 11 may be fastened to or released from the stroller frame 1. In this embodiment, the anchor dock 11 is extended from a folding joint 12. The anchor dock 11 has at least one latch section 3 (in this embodiment, the latch section 3 is a slot) to couple with the latch member 25 of the handle 22 to form an anchor condition. There is a sliding trough 4 located below the latch section 3 to house a sliding display member 5. The display member 5 has at least one display surface 51. When the latch member 25 of the car seat 2 is not latched on the latch section 3 of the anchor dock 11, the display member 5 is pushed by an elastic element 6 and extended into the latch section 3 (as shown in FIG. 5). There is a display spot 7 located on an outer side of anchor dock 11, corresponding to the sliding trough, 4 to indicate and confirm the movement of the display member 5.

By means of the structure set forth above, after the car seat 2 is mounted onto the stroller frame 1, the latch member 25 of the body 21 or the handle 22 may be wedged in the latch section 3 of the anchor dock 11. As the display member 5 is extended into the latch section 3, the entering latch member 25 pushes the display member 5 moving downward (as shown in FIG. 6). Hence users can clearly see the display surface 51 of the display member 5 through the display spot 7 (the display surface may be coated with different colors to indicate the safety position) to make sure that the latch member 25 has been wedged in the latch section 3. Thereby incomplete coupling of the car seat 2 and the stroller frame 1 may be prevented, and the risk of loosening the car seat 2 from the stroller frame 1 may be avoided to achieve the desired safety effect.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A latch indication apparatus for strollers and car seats to be installed on a stroller frame which has an anchor dock, comprising:
a car seat movably mounted onto the stroller frame having at least a body to accommodate a child and a handle for carrying the body; and
an anchor dock located on the stroller frame to couple with and brace the car seat having a display spot to indicate latch conditions of the car seat.

2. The latch indication apparatus of claim 1, wherein the handle is extended to form a latch member which is turnable with the handle to latch on the anchor dock for anchoring.

3. The latch indication apparatus of claim 1, wherein the anchor dock further has a latch section to couple with the latch member of the handle to form anchoring.

4. The latch indication apparatus of claim 3, wherein the latch section is a slot.

5. The latch indication apparatus of claim 1, wherein the display spot is located on one side of the latch section.

6. The latch indication apparatus of claim 1, wherein the display spot is an opening or a notch for viewing the location of the latch member.

7. A latch indication apparatus for strollers and car seats to be installed on a stroller frame, comprising:
an anchor dock fastened to the stroller frame including a latch section, a sliding trough and a display spot, the latch section being latchable with a latch member of a car seat to couple the car seat on the stroller frame; and
a display member housed in the sliding trough of the anchor dock having a display surface such that the display member has one end extended into the latch section before the car seat being coupled on the stroller frame, and the display member being pushed by the latch member when the car seat is coupled on the stroller frame to move within the range of the display spot to indicate the coupling condition of the car seat on the stroller frame.

8. The latch indication apparatus of claim 7, wherein the display surface of the display member has different display colors.

9. The latch indication apparatus of claim 7, wherein the display member is extended into the latch section by pushing from an elastic element.

10. The latch indication apparatus of claim 9, wherein the elastic element is a spring.
